(19) United States
(12) Patent Application Publication
(10) Pub. No.: US 2009/0019133 A1
(43) Pub. Date: Jan. 15, 2009

(54) SYSTEM, METHOD AND COMPUTER PROGRAM FOR UPDATING A WEB PAGE IN A WEB BROWSER

(76) Inventor: Stephen Brimley, Stroud (GB)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 11/777,347

(22) Filed: Jul. 13, 2007

(51) Int. Cl. G06F 15/16

(52) U.S. Cl. 709/218

(57) ABSTRACT

A computer-readable medium storing computer-executable instructions for updating a web page in a web browser of a networked PC performs operations comprising receiving a web page transmitted from a networked server, comparing the web page with a previous web page, the previous web page including data input by a user through the web browser, packaging the differences between the web page and the previous web page as at least one update, using the web browser and the at least one update to update the web page and to display an updated web page in the web browser. Each page displayed by the web browser is updated, rather than being reloaded completely, thus giving responsiveness comparable with software installed on the PC, rather than that of a conventional web browser based application.

### BACKGROUND OF THE INVENTION

Conventionally, the operation of a web-based application, for example a shopping cart, publication or dating site, is achieved by server software preparing a form page (ie a web page containing form controls) in html or xhtml and then transmitting it to a web browser of a networked personal computer (PC). Subsequently, a browser user completes data on the form page and causes it to be transmitted back to the server software. Typically this would be by clicking a button within the form page, though the transmission might equally be triggered by other means, for example by client-side script responding to the changing value of a form control. On receipt of that data, the server software may then generate a further form page in response. This interactive process is repeated indefinitely until

The application has achieved its goal, for example, in the case of a shopping cart, a product or service has been purchased.

A problem of this conventional application system, is that each time data is transmitted to the server from the web browser, the form page has to redisplay completely, and a new page is recorded in the browser's history. This is very time consuming and slows down the session, ie the sequence of form pages that are sent to the browser from the system server for presentation to the web browser user.

Furthermore, the fact that during each interaction cycle a new form page is displayed to the user interrupts the user's experience. F or example, consider the situation where a user selects an item from a textual list of items by clicking on its name. This causes data, including the fact that the item has been selected, to be transmitted to the server software. The server software than re-generates the form page, this time including a picture of the selected item next to the textual list, and returns that page to the user. In this conventional system, rather than the picture instantly appearing on the form page, the whole page is re-displayed resulting in a discontinuity in the user's experience. Worse than that, if the form page had been scrolled down to reveal the list of items at the time of transmission, the re-displayed form page will be located at the top of the form page, thus forcing the user to scroll down once more in order to relocate the list and its associated illustration.

Furthermore, in a session each page in the sequence is generated depending on the data submitted in the user's response to the previous page. Therefore, a context is built up for the application that is peculiar to that particular session. If the browser user clicks the browser's back button to display an earlier page in the sequence, and then interacts with the form controls on that page, rather than on the latest generated page, this can mean that any context held by the server software in relation to the session is rendered out of step with the actual information displayed to the user and transmitted to the server software. This can cause some applications to behave incorrectly.

### SUMMARY OF THE INVENTION

According to the first aspect of the present invention there is provided a computer-readable medium storing computer-executable instructions for updating a web page in a web browser of a networked PC by performing operations comprising comparing a page produced by server software with a previous page, transmitting a sequence of changes representing the differences between the two pages to the networked PC, and using an interpretation means to interpret the sequence of changes to update the web page in the browser.

It is an advantage of the invention that the web browser can be updated without having to reload an entire web page, because only the updates are loaded. This means that a browser based application transmitting data appears to the user as responsive as a directly loaded software package.

The interpretation means may be transmitted to the networked PC together with the sequence of changes representing the differences between the two pages.

The operations of receiving a web page transmitted from a server, comparing the web page with a previous web page, and transmitting a sequence of changes representing the differences between the two pages to the networked PC may be performed by a first software element.

The first software element may be adapted to be run on the server.

Alternatively, the first software element may be adapted to run on a separate networked processor.

Said interpretation means may be provided by a second software element.

The second software element may be adapted to be run on the web browser.

According to a second aspect of the invention there is provided a system for updating a web page in a web browser of a PC, comprising a server coupled to the PC through an electronic data network, server software for generating web pages for transmission to the web browser, a first means for comparing a web page transmitted from the server with a previous web page, and transmitting a sequence of changes representing the differences between the two pages to the networked PC, and an interpretation means for interpreting the sequence of changes to update the web page in the browser.

The interpretation means may be incorporated in the first means and may be transmitted to the networked PC together with the sequence of changes representing the differences between the two pages.

The first means for comparing a web page transmitted from the server with a previous web page, may be a first software element.

The first software element may run on the server.

Alternatively, the first software element may run on a separate processor coupled to the electronic data network.

The interpretation means may be a second software element.

The second software element may run on the web browser.

The first means and interpretation means may act outside the server logic and only function if client-side script detects that the web browser is capable of supporting the first means.

According to a third aspect of the invention there is provided a method for updating a web page in a web browser of a PC comprising;

at a server coupled to the PC through an electronic data network, using server software to generate web pages for transmission to the web browser,

comparing a web page transmitted from the server with a previous web page using a first software means, transmitting a sequence of changes representing the differences between the two pages to the networked PC, and interpreting the sequence of changes to update the web page in the browser using interpretation software.

The interpretation software may also be transmitted to the networked PC with the sequence of changes.

The first software means may run on the server.

Alternatively, the first software means may run on a separate processor coupled to the electronic data network.

The interpretation software may run on the web browser.

The interpretation software means may utilise the dynamic html capabilities of the web browser.

In a fourth aspect of the invention a pair o C software elements are provided, which may be stored on a computer-readable medium, to intervene in a process whereby server software running on a networked server produces a fresh page in response to data submitted from a web browser of a separate networked PC as a result of a user's interaction with a previous page and that fresh page is then displayed in the web browser completely replacing the original page,

the first software element comparing the fresh page produced by the server software with the previous page and transmitting a sequence of changes representing the differences between the two pages,

the second software element, being implemented as client-side script and being incorporated as part of the previous page, to interpret the sequence of changes as changes to a currently displayed web page and utilising the dynamic html capabilities of the web browser to bring about the changes.

### BRIEF DESCRIPTION OF THE DRAWINGS

For a better understanding of the present invention, and to show more clearly how it may be carried into effect, reference will now be made, by way of example, to the accompanying drawing, in which:

FIG. 1 is a schematic illustration of the invention software.

### DETAILED DESCRIPTION OF THE ILLUSTRATIVE EMBODIMENT

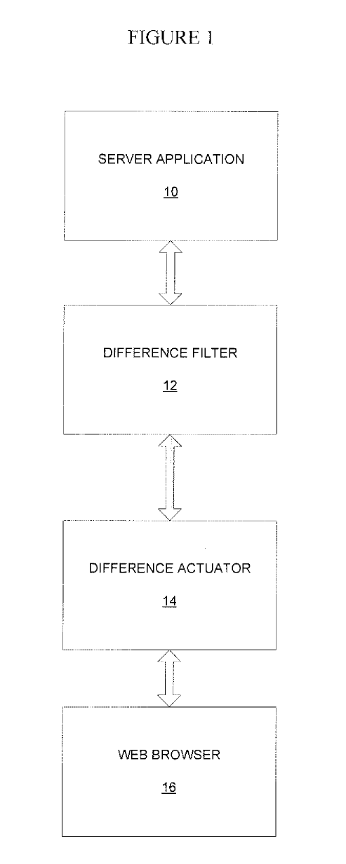

Referring to FIG. 1, a network for supplying a web based application includes a networked server and at least one networked PC. Conventional application software 10 loaded on the server prepares a form page (ie a web page containing form controls) in html or xhtml for transmission to a web browser 16 of the PC. A first software element 12 forming part of the invention, known as a difference filter, is loaded onto and runs on the server or on a separate networked processor. The difference filter can be implemented as an extension to the original server software or can be completely independent of the server software. A second software element or interpretation element 14 forming part of the invention, known as a difference actuator, is written in a suitable scripting language and is incorporated in the difference filter for transmission to the web browser in a form page. This may be the first page in a session. Usually, it would be the first page in a session.

As explained in the background of the invention, a sequence of form pages that are sent from the system server for presentation to the web browser user is called a session. In a typical session, the difference filter 12 processes each form page generated by the server software and compares it to the previously generated form page. It then packages the differences between the two pages as at least one, or a list of updates and transmits the updates to the difference actuator 14.

The difference actuator 14 does two things. Firstly, it replaces the standard browser data submission mechanism by intercepting those events that would normally cause data to be submitted by the browser 16. For example, when the user clicks a submit button, instead of the data being posted to the server in the normal way, the difference actuator 14 transmits it to the server, via the difference filter 12, in such a way that the responses generated by the server software 10 are returned to the difference actuator 14 via the difference filter 12.

The difference actuator 14 thus receives the list of updates generated by the difference filter 12 in response to the previous form page's data. It then updates the currently displayed form page to reflect those differences using the dynamic html capabilities inherent in the web browser 16. The result of this is that each form page generated by the server software 10 other than the first one is displayed in the web browser 16 as it would have been without the presence of the difference filter 12 and the difference actuator 14, but with several significant advantages.

When a new form page is displayed, instead of re-displaying the entire page from the top, only those parts that have changed are updated. This has the effect that the form page behaves much more responsively, with less delay and less disruption than if the page was completely redisplayed each time data was sent to the server. Also, a new page is not recorded in the web browser's history. For example, if the user clicks the web browser's back button, the web browser 16 will not now show the previous page in the sequence generated by the server software 10. This is highly beneficial, because it greatly improves the session management and avoids re-submission of data by a user.

Furthermore, if the form page has been scrolled prior to an action that causes data to be submitted, instead of being re-positioned back at the top of the page as would happen without the presence of the difference actuator 14, it can be left scrolled as before. This allows the server software to alter the current form page in response to such an action without disrupting the user's interaction with that form page.

Another advantage is that the response time is improved because the web browser 16 is doing less work. The volume of data transmitted from the server to the web browser 16 is significantly reduced, which improves response times and reduces network traffic.

The difference filter 12 and difference actuator 14 have the ability to act outside the main server logic, and only function if client-side script detects that the web browser 16 is capable of supporting the difference actuator 14. This means that in circumstances where the differencing technology cannot be used, either because the web browser 16 cannot support it or because client-side scripting is disabled, the application and web browser software will continue to work, albeit without the advantages afforded by the software of the invention.

The invention is applicable to both internet and intranet applications. The software of the invention can be loaded onto any suitable carrier or processing device. One server may communicate with one or a plurality of personal computers or networked information processing, display and input devices. The network my be hard wired or wireless, or a combination of both hard wired and wireless connections.

Terms used in the description of the invention are defined below.

Client-Side Script

Program code written in a scripting language and contained within a web page.

Dynamic html

This is the name given to the provision, by a browser manufacturer, of a program interface that allows code written in a scripting language to manipulate the contents of the currently displayed web page.

Form Page

A web page containing form controls.

Form Control

A fragment of html and/or xhtml contained within a web page that causes a user interface element to be presented to the user of a web browser. Such user interface elements include, but are not restricted to:

buttons

menus

checkboxes

radio buttons

menus

text input boxes

Scripting Language

A computer language that allows program code to be embedded within a web page such that (amongst other things) the program code:

can respond to events triggered by user interactions with the web page

can cause data to be transmitted to the server software

can use the dynamic html capabilities of the web browser to directly manipulate the html and/or xhtml presented to the user of the browser

Server Software

Software running on a server computer that is designed to generate html and/or xhtml pages to send to a web browser in response to requests and data sent from the web browser.

Session Management

The management of web-based applications that work through a web browser. In such applications a sequence of form pages are sent to the browser for presentation to the user. Such a sequence is termed a “session”. Each page in the sequence is generated depending on the user's response to previous pages. Thus a context is built up for the application that is peculiar to that particular session.

Web Browser

A software application that enables a user to display and interact with text, images, and other information typically located on a web page at a website on the World Wide Web or a local area network. Web browsers format html and/or xhtml information for display, so the appearance of a web page may differ between browsers.

Web Page

A block of text encoded in html and/or xhtml which, when sent to a web browser, causes the browser to present textual information and other data such as images to the browser's user.

It is understood that variations may be made in the foregoing without departing from the scope of the invention. For example, the elements and teachings described may be combined in whole or in part. In addition, one or more of the elements and teachings described may be omitted, at least in part, and/or combined, at least in part, with one or more of the other elements and teachings described.

Although an illustrative embodiment of the invention has been shown and described, a wide range of modification, changes and substitution is contemplated in the foregoing disclosure. In some instances, some features of the invention may be employed without a corresponding use of the other features. Accordingly, it is appropriate that the appended claims be construed broadly and in a manner consistent with the scope of the invention.

1. A computer-readable medium storing computer-executable instructions for updating a web page in a web browser of a networked PC by performing operations comprising comparing a page produced by server software with a previous page, transmitting a sequence of changes representing the differences between the two pages to the networked PC, and using an interpretation means to interpret the sequence of changes to update the web page in the browser.

2. A computer-readable medium as claimed in claim 1, wherein the interpretation means may be transmitted to the networked PC together with the sequence of changes representing the differences between the two pages.

3. A computer-readable medium as claimed in claim 1, wherein the operations of receiving a web page transmitted from a server, comparing the web page with a previous web page, and transmitting a sequence of changes representing the differences between the two pages to the networked PC i ay be performed by a first software element.

4. A computer-readable medium as claimed in claim 3, wherein the first software element is adapted to be run on the server.

5. A computer-readable medium as claimed in claim 3, wherein the first software element is adapted to run on a separate networked processor.

6. A computer-readable medium as claimed in claim 1, wherein said interpretation means may be provided by a second software element.

7. A computer-readable medium as claimed in claim 1, wherein the interpretation means is adapted to be run on the web browser.

8. A system for updating a web page in a web browser of a PC, comprising a server coupled to the PC through an electronic data network, server software for generating web pages for transmission to the web browser, a first means for comparing a web page transmitted from the server with a previous web page, and transmitting a sequence of changes representing the differences between the two pages to the networked PC, and an interpretation means for interpreting the sequence of changes to update the web page in the browser.

9. A system as claimed in claim 8, wherein the interpretation means is incorporated in the first means and is transmitted to the networked PC together with the sequence of changes representing the differences between the two pages.

10. A system as claimed in claim 8, wherein the first means for comparing a web page transmitted from the server with a previous web page is a first software element.

11. A system as claimed in claim 10, wherein the first software element runs on the server.

12. A system as claimed in claim 10, wherein the first software element runs on a separate processor coupled to the electronic data network.

13. A system as claimed in claim 8, wherein the interpretation means is a second software clement.

14. A system as claimed in claim 8, wherein the interpretation means runs on the web browser.

15. A system as claimed in claim 8, wherein the first means and interpretation means act outside the server logic and only function if client-side script detects that the web browser is capable of supporting the first means.

16. A method for updating a web page in a web browser of a PC comprising;
at a server coupled to the PC through an electronic data network, using server software to generate web pages for transmission to the web browser,
comparing a web page transmitted from the server with a previous web page using a first software means, transmitting a sequence of changes representing the differences between the two pages to the networked PC, and interpreting the sequence of changes to update the web page in the browser using interpretation software.

17. A method for updating a web page in a web browser of a PC as claimed ill claim 16, wherein the interpretation software is transmitted to the networked PC with the sequence of changes.

18. A method for updating a web page in a web browser of a PC as claimed in claim 16, wherein the first software means is run on the server.

19. A method for updating a web page in a web browser of a PC as claimed in claim 16, wherein the first software means is run on a separate processor coupled to the electronic data network.

20. A method for updating a web page in a web browser of a PC as claimed in claim 16, wherein the interpretation software runs on the web browser.

21. A method for updating a web page in a web browser of a PC as claimed in claim 16, wherein the interpretation software utilises the dynamic html capabilities of the web browser for updating and displaying the or each web page.
